(19) United States
(12) Patent Application Publication
(10) Pub. No.: US 2015/0036325 A1
(43) Pub. Date: Feb. 5, 2015

(54) SOLAR-POWERED FIREFLY JARS AND DECORATIVE ILLUMINATED BOTTLES

(71) Applicant: RSR Sales, Inc. d/b/a Echo Valley Quality Home & Garden Products, Ann Arbor, MI (US)

(72) Inventor: Richard Cohen, Ann Arbor, MI (US)

(21) Appl. No.: 14/446,802

(22) Filed: Jul. 30, 2014

Related U.S. Application Data
(60) Provisional application No. 61/860,570, filed on Jul. 31, 2013.

(51) Int. Cl. F21S 10/06; F21V 23/00; F21V 33/00; F21S 8/06; F21S 9/03

(52) U.S. Cl. CPC F21S 10/06; F21S 8/061; F21S 9/037; F21V 33/0028; F21V 23/009; F21W 2121/00
USPC 362/124

(57) ABSTRACT

A solar-powered decorative article includes a module having an upper surface and a lower structure configured for coupling to the mouth of a transparent or translucent vessel. A solar panel is supported on the upper surface of the module, and a battery, disposed within the module, is recharged by the solar panel. A plurality of light-emitting diodes (LEDs) are suspended from the bottom surface of the module by tethers. A controller is operative to control each LED from OFF or low brightness to a higher brightness over time to produce decorative lighting patterns. The lower structure of the module may include a stopper configured for coupling to the mouth of a bottle, or threads configured for coupling to a jar having a threaded mouth. Each LED may be covered with a decorative, simulated firefly shell, with the controller being operative to control the LEDs to simulate lighting patterns generated by real fireflies.

### REFERENCE TO RELATED APPLICATION

This application claims priority from U.S. Provisional Patent Application Ser. No. 61/860,570, filed Jul. 31, 2013, the entire content of which is incorporated herein by reference.

### FIELD OF THE INVENTION

This invention relates generally to decorative illuminated jars and bottles and, in particular, to simulated firefly jars and decorative, illuminated bottles.

### BACKGROUND OF THE INVENTION

In places where fireflies or lightening bugs appear in summer, it is a fun activity for children to collect them in jars so they can watch them light up. It would be enjoyable to extend this activity to times and places where such insects cannot be collected. It would also be advantageous to find more decorative uses for used or spent bottles such as wine bottles.

### SUMMARY OF THE INVENTION

This invention resides in a solar-powered decorative article. The article includes a module having an upper surface and a lower structure configured for coupling to the mouth of a transparent or translucent vessel. A solar panel is supported on the upper surface of the module, and a battery, disposed within the module, is recharged by the solar panel. A plurality of light-emitting diodes (LEDs) are suspended from the bottom surface of the module by tethers, each tether including two wires interconnected to electronics in the module. The electronics, operated by the battery, includes a controller operative to control each LED from OFF or low brightness to a higher brightness over time to produce decorative lighting patterns visible within the vessel.

The lower structure of the module may include a stopper configured for coupling to the mouth of a bottle, or threads configured for coupling to a jar having a threaded mouth. Each LED may be covered with a decorative, simulated firefly shell, with the controller being operative to control each LED from OFF or low brightness to relatively high brightness over time to simulate lighting patterns generated by real fireflies. The tethers are preferably at different lengths such that the LEDs are at different height levels within the vessel. The controller may be operative to vary the timing of the LEDs such that such some or all of the LEDs are periodically ON but at different brightness levels. Alternatively, the controller operative to cause the LEDs to illuminate or flash at different times.

### BRIEF DESCRIPTION OF THE DRAWINGS

FIG. 1 shows a simulated firefly jar according to the invention;

FIG. 2 shows a block diagram of the electronics used in the embodiments of FIGS. 1 and 4;

FIG. 3 illustrates the way in which the LEDs may be operated to achieve a decorative effect; and

FIG. 4 depicts a wine bottle embodiment of the invention.

### DETAILED DESCRIPTION OF THE INVENTION

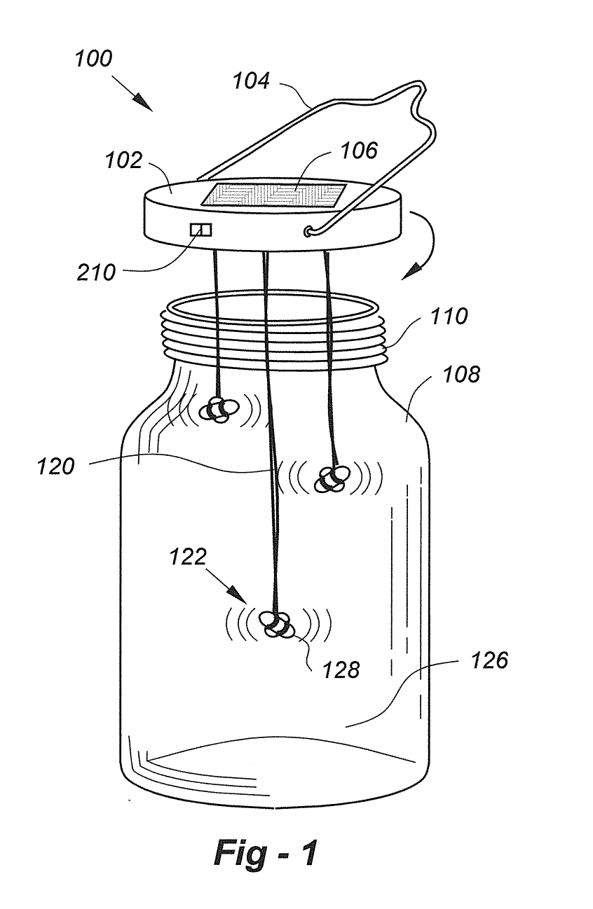

One embodiment of this invention simulates fireflies caught in a jar. This embodiment, depicted in FIG. 1 at 100, includes a cap-shaped housing 102 that attaches to a jar 108 through a threaded connection 110. The invention may either be provided with a jar, or may be configured for coupling to an existing jar such as a “Mason jar.” Non-threaded connections are also possible.

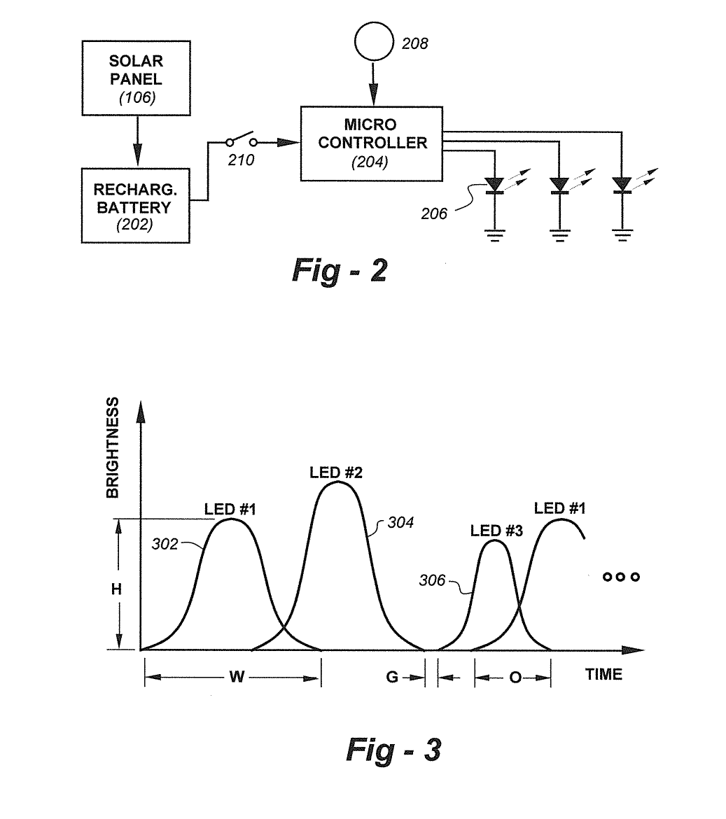

The cap 102 has an upper surface with a solar panel 106 interconnected to electronics described with reference to the block diagram of FIG. 2. A hanger 104 may optionally be provided to suspend the article from a hook. Real or simulated “grass” 126 may be provided as part of a kit to go into jar 108.

A plurality of simulated “fireflies” 122 are suspended by individual tethers 120 from the cap 102. Each tether includes two wires attached to a light source in each respective firefly. In the preferred embodiment there are three fireflies with different length tethers so they assume different heights in the jar when assembled. Further, each tether is preferably made from fine wires so the tethers are difficult to see while allowing the fireflies to “jiggle” if the jar is gently shaken.

The light sources are yellow, orange or yellow-orange LEDs, though reddish or white sources may alternatively be used. Low-or medium brightness yellow, orange or yellow-orange LEDs are preferred to simulate real fireflies. Each LED is embedded or overmolded into a plastic “fly” shape with wings and/or stripes, again to appear as a real firefly.

FIG. 2 is a block diagram of the electronics housed in cap 102. Solar panel 106 charges a rechargeable battery that provides power to microcontroller 204. Microcontroller 204 provides power to LEDs 206 in accordance with a program that modules their brightness to appear real, as described with reference to FIG. 3. An optional ON/OFF switch made be provided, on the underside of cap 102, for example.

In the preferred embodiment, a light sensor is included such that the battery charges during the day and the LED fireflies do not light up until a predetermined level of dusk or darkness is achieved. Either an optional photocell 208 may be used as a light sensor or, more preferably, solar cell 106 may be used.

FIG. 3 illustrates the way in which the LEDs may be operated to achieve a realistic effect with the understanding that other schemes are possible. Curve 302 represents the activation of LED #1 over time, curve 304 represents LED #2, and curve 306 represents LED #3. The pattern shown either repeats or microcontroller 204 can be programmed to introduce a level of randomness to the modulation pattern(s).

Depending up the way in which device 204 is programmed, the modulation of some or all of the LEDs may overlap with the others, such that one may becoming bright while another is dimming; two may becoming brighter at the same time; one, two, three may be ON at the same time, and so forth. The maximum brightness, H, may be the same or different for each LED, and the length of time that each LED is ON, W, may also be the same or different. The amount of overlap, O, between LED ON cycles may be the same or different, including instances where there is no overlap at all, resulting in a gap, G.

Preferably in this embodiment, however, each LED is controlled to alternate in relatively slow, smooth patterns from OFF or very low brightness to a higher or peak brightness over time. The peak brightness of each LED may be the same, and the timing curves of each LED may be slightly different so that at least at times, all of the LEDs are simultaneously ON. For example, each LED may go from low to high brightness in a different time period ranging of about a half-second to several seconds.

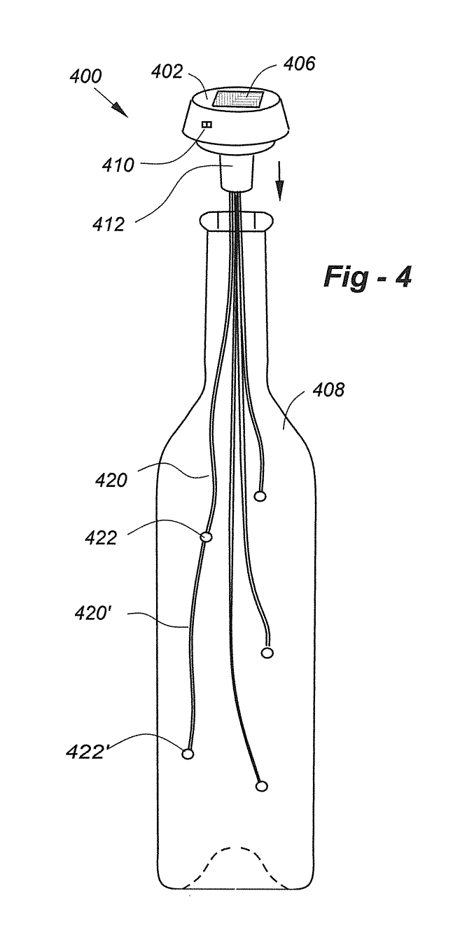

FIG. 4 depicts a wine bottle embodiment of the invention depicted generally at 400. This embodiment uses a module 402 with a stopper 412 configured to engage with the mouth of a bottle 408. Bottle 408 may be any size and may be transparent, including colored, or translucent, as with some champagne and sake bottles. For a “standard” wine bottle, stopper 412 may have a diameter on the order of ⅝ to 1″, and may be made of a compressible or rubberized material such as synthetic cork.

As with other embodiments of this invention, module 402 contains the electronics shown in FIG. 2, including optional on/off switch 410. As with the firefly embodiment, the module 402 drives LEDs such as 422 through interconnecting wires 420. Such interconnecting electrical tendrils may be configured to “jiggle” as in the firefly embodiment, or they may be more relaxed. As with the firefly embodiment, certain of the interconnects may continue form one LED to another, connecting them to light in series (i.e., 420′ to 422′), of the LEDs may be connected for independent operation.

In the bottle embodiment, the LEDs may be any color, and need not favor yellows or oranges since the point in this case is not to necessarily simulate fireflies. The LEDs may follow a lighting pattern of the type shown in FIG. 3, though more abrupt or “flashing” modalaties may be programmed since, again, the point on this embodiment is not necessarily to simulate fireflies. Since bottles such as wine bottles are taller than typical Mason jars, the longest interconnecting tendrils in the embodiment of FIG. 4 may be on the order of 11 inches (or longer for larger bottles such a “magnums.” Again, however, the various LEDs are preferably staggered at different lengths from module 402 to enhance the decorative effect.

1. A solar-powered firefly display, comprising:
a cap-shaped housing having an upper surface, a lower surface, and lower threads configured for coupling to a jar;
a solar panel supported on the upper surface of the cap-shaped housing;
a battery disposed within the cap-shaped housing and recharged by the solar panel;
a plurality of simulated firefly devices suspended from the bottom surface of the cap-shaped housing by tethers, each firefly device including a light-emitting diode (LED), and each tether including two wires interconnected to electronics in the cap-shaped housing; and
wherein the electronics includes a controller operative to control each LED from OFF or low brightness to relatively high brightness over time to simulate lighting patterns generated by real fireflies.

2. The display of claim 1, including three or more simulated firefly devices suspended from the bottom surface of the cap-shaped housing.

3. The display of claim 1, including tethers of different lengths such that the simulated firefly devices are at different height levels within the jar when the cap is attached.

4. The display of claim 1, wherein the LEDs emit colored light in the yellow-orange range.

5. The display of claim 1, wherein the tethers utilize sufficiently thin wires that the firefly devices jiggle when the jar is gently shaken.

6. The display of claim 1, wherein the controller is operative to vary the timing of the LEDs such that such some or all of the LEDs are periodically ON but at different brightness levels.

7. The display of claim 1, wherein the controller is operative to smoothly cycle the brightness of each LED with a time period on the order of 1 to 3 seconds, more or less.

8. A solar-powered decorative article, comprising:
a module having an upper surface and a lower structure configured for coupling to the mouth of a transparent or translucent vessel;
a solar panel supported on the upper surface of the module;
a battery disposed within the module, the battery being recharged by the solar panel;
a plurality of light-emitting diodes (LEDs) suspended from the bottom surface of the module by tethers, each tether including two wires interconnected to electronics in the module; and
wherein the electronics includes a controller operative to control each LED from OFF or low brightness to a higher brightness over time to produce decorative lighting patterns visible within the vessel.

9. The solar-powered decorative article of claim 8, wherein the lower structure includes a stopper configured for coupling to the mouth of a bottle.

10. The solar-powered decorative article of claim 8, wherein the lower structure includes threads configured for coupling to a jar having a threaded mouth.

11. The solar-powered decorative article of claim 8, wherein the LEDs are covered with a decorative, simulated firefly shell.

12. The solar-powered decorative article of claim 8, wherein the electronics includes a controller operative to control each LED from OFF or low brightness to relatively high brightness over time to simulate lighting patterns generated by real fireflies.

13. The solar-powered decorative article of claim 8, including three or more simulated firefly devices suspended from the bottom surface of the cap-shaped housing.

14. The solar-powered decorative article of claim 8, including tethers of different lengths such that the LEDs are at different height levels within the vessel.

15. The solar-powered decorative article of claim 8, wherein the electronics includes a controller operative to vary the timing of the LEDs such that such some or all of the LEDs are periodically ON but at different brightness levels.

16. The solar-powered decorative article of claim 8, wherein the electronics includes a controller operative to cause the LEDs to illuminate or flash at different times.
